(19) United States
(12) Patent Application Publication
(10) Pub. No.: US 2021/0025791 A1
(43) Pub. Date: Jan. 28, 2021

(54) SAMPLE PROCESSING SYSTEM AND METHOD FOR AUTOMATICALLY PROCESSING HISTOLOGICAL SAMPLES

(71) Applicant: INVEOX GMBH, Garching bei München (DE)

(72) Inventors: Dominik SIEVERT, München (AT); Maria SIEVERT, München (DE)

(21) Appl. No.: 16/981,190

(22) PCT Filed: Mar. 15, 2019
(86) PCT No.: PCT/EP2019/056524

§ 371 Date: Sep. 15, 2020

(30) Foreign Application Priority Data
Mar. 16, 2018 (EP) 18162231.7

(51) Int. Cl. G01N 1/28; G01N 35/00; G01N 35/04; G06K 7/14

(52) U.S. Cl. CPC G01N 1/28; G01N 35/00732; G01N 2001/002; G06K 7/1413; G01N 35/04

(57) ABSTRACT

The present invention relates to a sample processing system and method for automatically processing at least one of a histological, a pathological, a medical, a biological, a veterinary and an agricultural sample. The sample can be positioned in a container assembly that can be closed after depositing the sample therein and can be opened, particularly upon arrival to a laboratory equipped with a system according to the present invention. The system can comprise an imaging section that is configured to capture images of the container assembly and/or the sample; an opening section configured to automatically open the container assembly and to remove at least the sample or a plurality of samples from the container assembly or of different compartments in the container; a cassette-handling section configured to support the sample for further handling; and an output section configured to provide the sample for further examination. All steps can be automated, and a handover can be controlled centrally and/or locally. The sample processing system according to the preceding embodiment can further comprise the container assembly with a preserving, conserving, fixating and/or nurturing fluid. The fluid can be a liquid and/or gas and/or ambient air, depending on the needs. The system can further comprise a fluid-handling section that is configured to automatically remove the fluid from the container assembly and can be further configured to perform at least one of handling and disposing of the fluid.

### FIELD

The present invention relates to sample processing system and method for automatically processing particularly histological and/or pathological samples.

### BACKGROUND

The term pathology itself is usually referred to the study of disease in general, incorporating a wide range of bioscience research fields and medical practices (including plant histology or pathology and veterinary histology or pathology), or more narrowly to describe work within the contemporary medical field of “general pathology”, which includes a number of distinct but inter-related medical specialties that diagnose disease mostly through analysis of tissue, cell, and body fluid samples.

As a field of general inquiry and research, pathology addresses four components of disease: cause, mechanisms of development (pathogenesis), structural alterations of cells (morphologic changes), and the consequences of changes (clinical manifestations). In common medical practice, general pathology is mostly concerned with analyzing known clinical abnormalities that are markers or precursors for both infectious and non-infectious disease and is conducted by experts in one of two major specialties, anatomical pathology and clinical pathology. Further divisions in specialty exist on the basis of the involved sample types (comparing, for example, cytopathology, hematopathology, and histopathology), organs (as in renal pathology), and physiological systems (oral pathology), as well as on the basis of the focus of the examination (as with forensic pathology).

The largest amount of samples origin from biopsies and are tissue samples. Presently they are collected by doctors and further downstream handled by staff. The biopsy samples are put into a container with preservation liquids, shipped and then manually extracted from the containers in a laboratory for further examination.

This procedure can cause errors regarding the origin of the samples and also expose the staff to infectious or poisonous material.

There is not much art to automatize this procedure. DE 102015100727 A1 relates to a sample transfer device for receiving a sample, comprising a transfer rod designed to receive a sample holder, the sample holder being transferred to a processing or analysis unit in a chamber for purposes of transferring the sample. The sample transfer device is arranged for measuring a physical quantity within the sample transfer device.

KR 101623431 B1 relates to a pathological diagnosis classifying apparatus for a medical image and a pathological diagnosis system using the same and, more particularly, to an apparatus and a system capable of efficiently classifying a medical image through learning based on machine-learning and performing pathological diagnosis. The present invention provides the pathological diagnosis classifying apparatus for the medical image and the pathological diagnosis system using the same, in which the pathological diagnosis classifying apparatus for the medical image includes: a feature extraction unit for extracting feature data with respect to an input image by a feature extraction variable; a feature vector conversion unit for converting the extracted feature data into a feature vector by a vector conversion variable; and a vector classification unit for classifying the feature vector by a classification variable to output a pathological diagnosis classification result with respect to the input image. The feature extraction unit, the feature vector conversion unit, and the vector classification unit learn from a first tagged image having a first tag indicating lesion existence and pathological diagnosis data, a second tagged image having the first tag and a second tag indicating location data of the lesion, and an image without tag data.

U.S. Pat. No. 6,881,579 B2 relates to an apparatus and methods for processing samples on the surface of supports that are contained in support housings. Biopolymer features are attached to the surfaces of the supports. An apparatus comprises an input element, a holding device for holding a plurality of support housings, one or more fluid dispensing stations, and an output element. Each of the support housings contains a support having attached thereto a plurality of biopolymer features. The holding device is movably mounted with respect to other components of the apparatus. The holding device is adapted to receive a support housing from the input element. The output element is adapted to receive a support housing from the holding device. The apparatus is adapted to index each support housing for a predetermined operation. In use, each of the support housings is moved to one or more processing stations by means of the movable holding device. The location and identity of each of the support housings is indexed. Fluid is applied to the surface of each of the supports at the processing stations to process the samples. Each of the support housings is moved away from the fluid dispensing stations, and fluid is physically removed from each of the supports within the support housings.

U.S. Pat. No. 7,556,777 B2 relates to a composite modular system for handling biological sample vials and slides comprises a vial scanner configured to read indicia on the sample vials, a slide labeler configured to mark the slides, a cap manipulator configured to uncap and cap the vials, and a controller, where all other elements are in communication with the controller and the system outputs the uncapped vial and the marked slide.

U.S. Pat. No. 8,535,642 B2 relates to a diagnostic system with a handling system that has a loading bay to receive and hold a plurality of carriers. An identification device is configured to identify an identifying feature of the carriers to determine the type of contents loaded on each carrier. A transporter transports the carriers from the loading bay to a first or second location depending on the determined type of contents on each carrier. The transporter has random access to the plurality of carriers in the loading bay. A diagnostic process is conducted using the contents. A carrier, such as for reagents, has one or more holding portions, at least one of which can be moved or rotated with respect to the body of the carrier for mixing or stirring the contents of a container coupled therewith. Also, a retention member can be associated with a positioning device, such as a carousel, to lock and unlock the carrier with respect thereto.

U.S. Pat. No. 8,691,148 B2 provides a disclosure related to a small-sized automatic analyzer being compact, enabling a large number of analysis items to be carried out, and having a high processing speed. The automatic analyzer is particularly suitably applied to a medical analyzer used for qualitative/quantitative analysis of living body samples, such as urine and blood. A plurality of sample dispensing mechanisms capable of being operated independently of each other are provided to suck a sample from any one of a plurality of sample suction positions and to discharge the sucked sample to any one of a plurality of positions on a reaction disk. The automatic analyzer having a high processing capability can be thus realized without increasing the system size.

U.S. Pat. No. 8,698,644 B2 relates to a sample processing apparatus including: a sample processing unit configured to process a sample contained in a sample container; one or more detectors located to detect the sample container both before and after the sample contained therein is processed by the sample processing unit; and a controller configured to perform an operation to alert a user if the one or more detectors fail to detect the sample container after the sample processing unit processed the sample in the sample container.

U.S. Pat. No. 9,134,333 B2 provides to the public a sample processing apparatus comprising: an aspiration section for aspirating a sample from a sample container; a sample container take-out/returning section for taking out a sample container containing a sample from a sample rack holding a plurality of sample containers, and for returning the sample container, from which the sample has been aspirated, to the sample rack; a sample processing section for processing the aspirated sample; a transport section for transporting the sample rack to a take-out position for taking out the sample container from the sample rack; and a transport controller for controlling the transport section to transport the sample rack to a processing position for performing a predetermined process on another sample container held by the sample rack when one sample container has been taken out from the sample rack by the sample container take-out/returning section is disclosed.

U.S. Pat. No. 9,335,336 B2 further provides a processing station for automatically processing a biological sample, a system for automated real-time inventory control of consumables within a biological sample handling or assay instrument, a high throughput random access automated instrument for processing biological samples, an automated instrument for processing or analysis of a sample, and processes for automated mucoid detection and elimination. Methods of using the disclosed instruments, mucoid detection processes, and systems to process and/or analyze samples are also disclosed.

DE 102011055899 B4 relates to a method for automatically handling a sample container, wherein at least one sample container is taken up in a container carrier in a handling device and a lid is gripped by a gripper head with a predetermined gripping force and the lid is removed by a combined movement out of a translational and rotational movement from the sample container. Using an optical capturing device, the lid as well as the sample container are analyzed and are assigned to a lid and sample container type, and that, furthermore, a required torque is assigned to each lid and/or sample container type as required for removing the lid, and that, starting from the required torque, the gripping force of the gripper head is adjusted.

U.S. Pat. No. 9,381,524 B2 discloses a system for automatically processing a biological specimen that includes an elevator comprising a plurality of shelves configured to receive a plurality of sample trays. The trays may comprise a plurality of sample containers containing a sample and having a plurality of respective caps engaged therewith. The trays may further include a plurality of centrifuge tube racks each containing a plurality of centrifuge tubes. The system may include a first transport mechanism, a second transport mechanism and a third transport mechanism. The system may include a chain-of-custody device configured to read identifiers on each of the containers. The system may also include a pipetting device configured to remove a portion from the sample containers and dispense the sample into the centrifuge tubes.

EP 2538225 (A1) refers to a system for processing sample tubes comprising biological samples, the system comprising two or more work cells for processing samples, wherein in correspondence to at least two of the work cells, the system comprises one of the following units: a pipetting unit for withdrawing a volume of sample from a sample tube to be processed by the work cell and/or dispensing a volume of liquid into the sample tube, an analytical unit for determining at least one sample parameter of a sample contained in a sample tube. The system further comprises a decapping/recapping device for each of the at least two work cells for removing a closure from a sample tube and for reclosing the sample tube before it is transported to another work cell.

PCT/JP2013/080454 provides an automatic analyzer having no limitation on a range of a placeable position on a sample placement disk for patient specimens, emergency specimens, quality control samples, and calibration samples, and being capable of performing analysis while changing the number of simultaneously measurable samples for each type of each specimen is provided. In the automatic analyzer, either a calibration sample dedicated disk or a patient specimen dedicated disk is placed in an analyzing unit as a sample placement disk, and the analyzing unit has a disk identifying unit which identifies a type of the sample placement disk, and a computer identifies the type of the sample placement disk based on an identification result of the disk identifying unit, and performs analysis on a liquid sample based on the identified type of the sample placement disk.

DE 10041229 (A1) discloses a handling apparatus for cytological or histological preparations that has region which receives modular processing stations, wherein the apparatus includes several processing stations arranged in a housing, and a conveying device for supplying or removing objects or object carriers into the processing stations. A region allocated to the processing stations receives modular processing stations with fixed functions.

US 2007/0059209 A1 discloses system for a clinical lab that is capable of automatically processing, including sorting, of multiple specimen containers. The system comprises a central controller, a workstation, one or more analyzers, and an automated centrifuge. The workstation has automatic detectors for detecting the presence of a holder holding specimen containers. The workstation has a bar code reader for reading bar codes on the containers. The system has a transport subsystem, preferably a workstation robotic arm and an analyzer robotic arm for transporting the specimen containers, moving them to and from the workstation, to and from the analyzers, and to and from the centrifuge. The centrifuge is loaded with buckets containing specimen containers. The workstation can be provided with a balance system for balancing the weight of the buckets used. The workstation can also have a decapper for automatically removing caps from the specimen containers.

JP 2010-118028 A introduces a sample test automation system which is capable of reducing the workload of an operator and precisely carrying out necessary processes of each of samples without stagnation. In the sample test automation system, a sample tray on which a plurality of samples can be installed is prepared, an identifier for distinguishing the sample tray is attached to the sample tray, a sample introducing unit is provided with an identifier reading apparatus which reads the identifier of the sample tray 120, and information about the samples is switched based on the read identifier of the sample tray.

WO 2017/184244 A1 provides an automated analyzer comprising a housing, a robotic arm comprising an end effector, the end effector comprising a body rotatably connected to an articulating arm and first and second fingers coupled to the body and being moveable relative to each other in a first direction, each of the fingers having an engagement feature projecting inwardly from each of the first and second fingers and toward the other of the first and second fingers, the engagement feature being configured to engage a recess of an article wherein the recess is configured to receive the engagement feature such that the robotic arm can carry the article that is suspended from the first and second fingers when the engagement features are so engaged with the article. The automated analyzer further comprises a shuttle platform for receiving a shuttle carrying sample containers , the containers carrying sample to be evaluated by the analyzer and the shuttle platform comprising a jaw assembly that automatically moves from an open position to a closed position the jaw assembly comprising engagement members that do not contact the bottom portion of the sample containers carried by the shuttle when the jaw assembly is in an open position and engages the bottom portion of the sample containers when the jaw assembly is in the closed position.

### SUMMARY

It is the object of the present invention to provide an improved or alternative histological and/or pathological sample processing system and method for automatically processing histological and/or pathological samples.

This object is attained with the subject matter as recited in the embodiments and/or claims.

The present invention relates to a sample processing system for automatically processing at least one of a histological, a pathological, a medical, a biological, a veterinary and an agricultural sample. The sample can be positioned in a pathology assembly that can be closed after depositing the sample therein and can be opened, particularly upon arrival to a laboratory equipped with a system according to the present invention. The system can comprise an imaging section that is configured to capture images of the pathology assembly and/or the sample; an opening section configured to automatically open the pathology assembly and thus forms a container assembly. From the container assembly, at least the sample or a plurality of samples can be removed from the container assembly or of different compartments in the container. A cassette-handling section configured to support the sample for further handling and an output section configured to provide the sample for further examination can be supplied. All steps can be automated, and a handover can be controlled centrally and/or locally.

The sample processing system according to the preceding embodiment can further comprise the container assembly with a preserving, conserving, fixating and/or nurturing fluid. The fluid can be a liquid, gas, gel and/or ambient air, depending on the needs. The system can further comprise a fluid-handling section that is configured to automatically remove the fluid from the container assembly and can be further configured to perform at least one of handling and disposing of the fluid. Further details and embodiments are disclosed below.

The system can further comprise a waste and consumables section that is configured to dispose of at least the fluid and/or one or more parts of the container assembly, preferably a container lid and/or a container body and/or an arrangement to support empty cassettes that are not further used for the handling and examination of the sample.

The system can further comprise a cassette management section configured to automatically attach a frame to a filter and thus form a cassette, the filter preferably supporting the sample for further examination. The frame may further comprise a lid.

The system can further comprise an input section for automatically feeding the container assembly with the sample into the downstream system or downstream sections of the system. The input section can be configured to extract a single container assembly from a plurality of container assemblies positioned in a common support. Additionally, or alternatively, it can be configured to feed in single container assemblies, sequentially and/or in parallel.

The system can also comprise a central controlling component controlling at least two of the input section, the imaging section, the fluid-handling section, the cassette-handling section, the output section, the waste and consumables section and/or the cassette management section. The central controlling component can be connected with the sections by a bus structure. The system can further comprise a digital storage for providing information to or storing information from the system, preferably at least one of patient and sample information.

The digital storage can be at least in part remotely located, such as in a cloud. A combined version with local, remote servers and/or the cloud can be present as well.

The opening section can be configured to remove a cap from a pathology assembly by de-capping, the de-capping preferably comprising an unscrewing and/or unlatching etc. of one or more cap elements. This is further described below. The pathology assembly may be also closed by other arrangements that can be opened, such as a folding, swing out configuration etc.

The sample processing system according to the present invention can comprise at least one of the further arrangements: the input section being arranged in an input module; the imaging section and the opening section can be arranged in an imaging and opening module; the fluid-handling section can be arranged in a fluid-handling module; the cassette-handling section can be arranged in a cassette-handling module; the output section can be arranged in an output module; the waste and consumables section can be arranged in a waste and consumables module; and/or the cassette management section can be arranged in a cassette management module.

The sample processing system can further comprise at least an interface transferring a sample between at least one of the following modules: the input module and the imaging and opening module; the imaging and opening module and the fluid-handling module; the fluid-handling module and the cassette-handling module; the cassette-handling module and the output module; and/or the cassette management module and the cassette-handling module.

The sample processing system can further comprise a module controlling component for at least one of the modules. This module controlling component can be arranged locally with the module or remotely from the module. Further it may communicate with a/the central controlling component.

The sample processing system can further comprise an at least partially closed frame configured to at least provide one of: a structure to accommodate the modules; protection of at least one of the modules from environmental influence; chemical protection of the environment from the effects of hazardous fluid and/or vapor by at least one of a fluid and/or gas tight hood and/or at least one of a fluid and/or gas vent; and/or physical protection of the environment from mechanical movements of at least one of the modules.

Further, the frame can be configured to protect an operator or other persons from hazardous contact with any element of the sample processing system or chemical solutions.

An input module for automatically feeding a container assembly with at least one of a pathological, a histological, a medical, a biological, a veterinary and an agricultural sample downstream, the input module in accordance with the present invention can comprise a support for at least one feeding device, such as a rack, a conveyer belt or a funnel, in the following referenced as rack. The one or a plurality of rack(s) can comprise at least one sample pathology assembly, preferably a plurality of sample container arrangements being located side by side, such as in a matrix arrangement.

The input module can comprise at least one of: a conveyor device, a first detector configured to read an identification of the rack, the first detector preferably being an optical and/or an electronic device reading out the identification of the rack; a second detector assessing the presence and/or position of the rack and/or the presence of at least one container assembly, the second detector preferably being at least one of an ultrasonic, an optical and an electronic sensor; and/or first conveyor system configured to transport at least one container assembly to an imaging and opening module. The first and second detectors can be one component with different tasks or software routines for different purposes or can comprise common elements or can be distinctly different components.

In accordance with the present invention, an imaging and opening module can be further provided for capturing images of at least one of a container assembly with at least one of a pathological, a histological, a medical, a biological, a veterinary and an agricultural sample and opening the container assembly. The imaging and opening module can comprise: a third detector to read out an identification code on the container assembly and/or to determine the size and/or the number of at least one sample and/or a fourth detector, preferably a camera to determine the size and/or the number of at least one sample. The third and further detector can be provided by one camera, optionally with different software for different identification purposes. The third and fourth detectors can also share common elements.

The third and fourth detectors can be controlled by one or a combination of an external PC or by an embedded controller.

The imaging and opening module can convey the or part of the information gained by the second detector and/or the third detector and/or the fourth detector to a laboratory information system (LIS) and/or to a central control device, like a work cell controller.

The imaging and opening module can be further configured to align the container assembly in a pre-determined position for the imaging and opening module or section.

The imaging and opening module can be further configured to place a container detected to comprise an error condition into an error position, preferably back into the rack or into an output position for failure.

The imaging and opening module can be further configured to handle the at least one container within at most 12 seconds, preferable within at most 10 seconds, more preferable within at most 8 seconds, even more preferable within at most 5 seconds, most preferably within at most 3 seconds.

The imaging and opening module can be further configured to enable substantially parallel execution of the container handling, at least in part and/or substantially sequential execution, preferably upon need.

The imaging and opening module can further comprise a second conveyor or transport system that is configured to transport an opened container assembly to a fluid-handling module.

A fluid-handling module in accordance with the present invention can be configured to remove fluid, such as liquid and/or gas, contained in the container assembly and collect the fluid. The fluid can be disposed of or re-collected. The fluid-handling module can be further configured to place a sample for further handling and examination in a pre-arranged and/or prepared condition, position etc. It can further be configured to dispose of the collected fluid to a waste and consumables module.

The fluid-handling module can further comprise a third conveyor system that is configured to transport a container assembly to a cassette-handling module.

A cassette-handling module in accordance with the present invention can be configured to remove and discharge a container body from a filter, the latter preferably supporting the sample. The cassette-handling module can further comprise a fifth detector to detect the emptiness and/or loading of the container body. In case that the container body is not empty it can be discharged to an error or default position.

The cassette-handling module can be further configured to receive a cassette and abut the filter supporting the sample to form a cassette that can be used for the further processing of the cassette and the sample contained therein/thereon.

The cassette-handling module can further comprise a fourth conveyor system that is configured to transport the cassette with the sample to an output module.

An output module in accordance with the present invention can be configured to eject the cassette to an unload-position, the unload position can be at least one basket to collect at least one cassette. The output module wherein the unload-position can be at least one of an arrangement to further handle the cassette; and/or an arrangement to further examine the sample.

A cassette management module in accordance with the present invention can be configured to supply a 2-dimensional and/or alphanumerical labeling to the cassette, the label comprising at least one of the following information: an identifier number of the processed sample containers; a status information, preferably the status being about urgency and/or external versus internal order; a kind of the sample; a time stamp and/or identifier of operator; a type of subsequent staining needed; and/or a classification of care to be observed.

The cassette management module can further offer different cassette types, which can comprise different colors or different features according to handling needs in the downstream phase of an inspection process.

Bulk entry of cassettes can be applied; such the cassettes can be entered in packages, in an organized manner like a roll or arranged on a board, or disorganized, like scattered in a basket or a bin.

The cassette management module can be further configured to label a cassette in a machine-readable form, preferably by at least one of applying a barcode onto the cassette, applying a QR code onto the cassette and/or applying a coding to a writable electronic device onto the cassette.

The present invention also refers to a method for automatically processing at least one of a histological, a pathological, a medical, a biological, a veterinary and an agricultural sample positioned in a container assembly that is configured to be opened, particularly by any system or device according to any of the preceding or below embodiments, the method comprising the following steps: capturing images of at least one of the pathology assembly, the container assembly and the sample, automatically open the pathology assembly, automatically removing at least the sample from the container assembly, supporting the sample for further handling and providing provide for further examination.

Once the container lid is removed from the pathology assembly, a container assembly is referenced.

If the container assembly comprises a conserving, fixating and/or nurturing fluid, the method can further comprise the step of automatically removing the fluid from the container assembly and at least one of the step of handling and disposing of the fluid.

The method can further comprise the step of automatically attaching a frame to a filter and thus forming a cassette, the filter preferably supporting the sample for further examination. Moreover, it can comprise the step of automatically feeding the container assembly with the sample into the downstream system and preferably extracting a single container assembly from a plurality of container assemblies in a common support.

The method can further comprise the step of controlling at least two of an input section, an imaging section, a fluid-handling section, a cassette-handling section, an output section, a waste consumables section and/or a cassette management section.

The method can further comprise the step of providing information to or storing information from the system, preferably at least one of a patient and sample information, preferably a laboratory information system (IS).

A further step of removing a cap from a container assembly body by de-capping can also be provided, the de-capping preferably comprising an unscrewing and/or unlatching etc. of one or more cap elements.

The present technology will now be discussed with reference to the accompanying drawings.

### BRIEF DESCRIPTION OF THE DRAWINGS

FIG. 1 depicts an embodiment of a system according to the present invention and configured to attain a substantially automated processing of pathological samples;

FIGS. 2a-h schematically depict the system to process pathological samples demonstrated in a modular embodiment.

### DESCRIPTION OF THE FIGURES

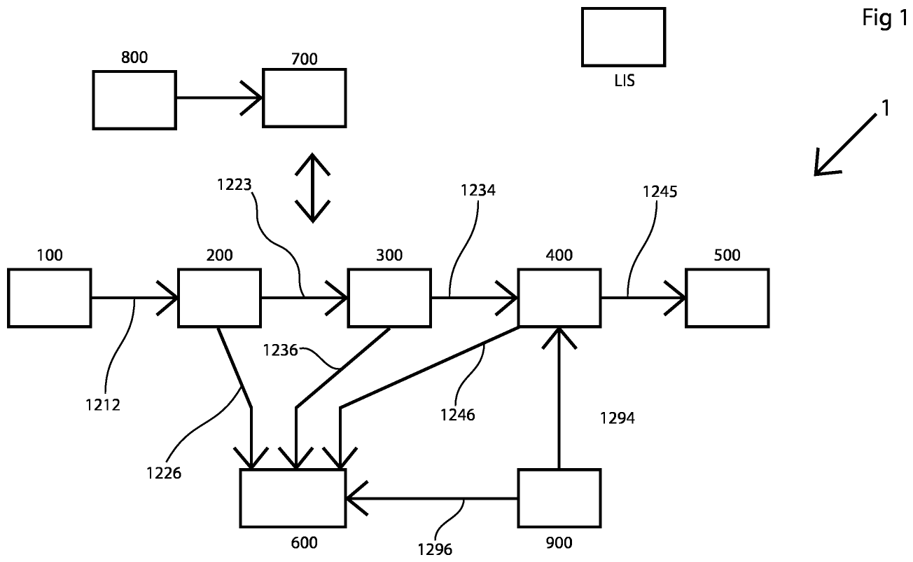

FIG. 1 depicts symbolically the components of a system 1 attained for a substantially automated handling of pathological samples. The samples can enter a pathological laboratory in racks or bags. Such racks or bags contain one or a plurality of containers each containing at least one pathological or histological sample are entered into a section 100. Section 100, that can also be configured as a module 100, can check the presence of at least one rack and pathology container(s) comprised therein. The sequence of incoming sample containers may be sorted or randomly organized.

The individual pathology containers can be extracted from the rack and can be conveyed by a conveying system 1212 to an imaging section 200 or imaging module 200. The imaging section 200 may further be constructed to also open a pathology container and thus becomes an imaging and opening section 200. The conveying system 1212 may as well be constructed as part of the imaging and opening section 200 that is adapted to fetch the individual pathology container from the preceding input section 100. Also, a combination of both can be realized, such that the input section 100 conveys the pathology sample to an intermediate station where the imaging and opening module 200 picks up the pathology sample.

Once the pathology container has entered the imaging and opening section 200, at least one image is taken about the pathology container to detect integrity of the pathology container and/or the compatibility of the pathology container with the system 1. The imaging section 200 is attained to detect a code that may be integrated in or on the pathology container with an identifier. Further, the pathology container may be rotated or adjusted to a position that can be advantageous for further processing. The identifier may further or alternatively be stored in machine readable device, such as a RFID tag.

Further, the imaging and opening section 200 may open the lid of a pathology container. Such an opening may be a decapping, an unthreading, an unlatching process or similar. Via a conveying system 1226 the lid or hatch of the pathology container may be disposed of into a waste and consumables section 600. Such a hatch or lid may be considered as a consumable component of the pathology container.

The remainder of the pathology container may then be labelled as container assembly. The container assembly containing the pathological sample can now be conveyed or transferred to a fluid handling section 300 that may be constructed as a fluid handling module 300. A conveyor system 1223 can, analogous to the conveyor system according to conveyor system 1212, again be either an active conveying system that is controlled by the imaging and opening section 200 and conveyed or transported to the fluid handling station 300, be controlled by the fluid handling system 300 or a combination thereof. Further, an independent provision can be configured to carry out the transporting process.

The fluid handling section 300, again also can be carried out as a fluid handling module 300. The fluid can be a liquid, but alternatively or additionally also gas, gel or air. The liquid can be formalin or any other liquid that, in dependency from the sample and the discretion of a practitioner, shall supply the sample with nurturing, conserving, infection-preventing capabilities or any other purpose. Further, a gas can be in the pathology container or the container assembly. Such a gas can be nitrogen or even air.

The fluid handling module 300 may by any way be handled to remove the fluid. Such a handling can be a pouring out by flipping the container assembly. To prevent sticking of the fluid, the flipping (or tilting) process may be carried out in steps.

As a result, the container assembly with the sample in it, may be positioned upside down or rather in an opposite orientation than it was entered into the fluid handling module 300. A sample can now be considered to be resting on a filter that is part of the container assembly.

The fluid can be conveyed to the waste and consumables section 600 by a conveyor system 1236.

As a next step, the sample resting in the upside-down container assembly, can be conveyed with a conveyor system 1234 to a cassette handling section 400 that can form a module, then addressed as cassette handling module 400. As described before, the conveyor system 1234 may be configured as being actively controlled by the fluid handling module 300 or by the cassette handling module 400, any combination of it, or by an independent device. Such an independent device could be formed by a master controller, an embedded or external computer, a central computing provision.

The cassette handling section 400 can be adapted to remove the container body from the filter, the filter supporting the sample. The removing of the container body (usually in a cup-or a jar shape) may be carried out by unscrewing the container body from the filter that provides a rest to the sample. The container body can be considered as a consumable part and be disposed of via a conveyor system 1246 into the waste handling section 600.

Before the container body is discharged to the waste and consumables section 600, a detector determines the emptiness of the container body. Should any part of the sample stick to the container body, an error condition can be activated and operator activity may be demanded. An error condition may be the transfer of the container body be conveyed to an error condition position with or without a signal transferred to an operator or to a central information system.

At this point, the cassette handling section 400 with the filter that supports the pathological sample can accept a cassette being presented by the cassette management section 900. The conveyor system 1294 in connection with the cassette handling section 400 abut a cassette to the filter that supports the sample. Thus, the sample is housed in a cassette that can further be handled, the sample can be examined and/or stored.

The conveyor system 1245 unloads the cassette that now contains the sample to an output module 500. Again, the control of this conveyor system may be organized by the cassette handling section 400 or by the output handling module 500, a combination thereof or an integrated or independent provision. The output module 500 can place the cassette(s) into a basket, a stack or in any desired provision made for the bulk storage of cassettes but can also hand over the cassette to a robot or a further examination- and/or handling machine.

A cassette management section 900, also be addressed as a cassette management module 900 can be configured to handle one or a plurality of cassettes. For the sake of clarity or lucidity, different colors or features of the cassettes may be provided and then conveyed via the conveyor system 1294 to the cassette handling module 400. Such different colors can provide a higher level of reliability within the further process of the examination and/or storage of the cassette supporting the sample. The cassette may further be marked, the marks can be checked prior to conveying via the conveyor system 1294. In the case that the marking comprises a failure, such as a misprint, a defective storage tag, a misalignment of the cassette or similar, the cassette with the defective (or incomplete) marks can be output to a failure position. Before the cassette is sent to an error position, a retry can be carried out and a recheck constituted.

Conveyor system 1296 may transport a support structure of the cassettes to the waste and consumables section 600.

A waste and consumables section 600 that may also be addressed as waste and consumables module 600 may collect the consumable parts of the sample container for further activity or disposal. Further, the fluid from inside the sample container may be collected and stored in an appropriate way. Some of the fluids may be hazardous or very expensive or for any other reason may need extended care.

Whereas each section or module 100, 200, 300, 400, 500, 600, 900 may comprise a local control authority, such like a computer or a specialized processor, work cell controller 800 may via a router or bus system 700 control either the sections itself or via instructing the local control authorities. Further the local control authorities may report various status information to the work cell controller 800, again via the router or bus system 700. This router or bus system 700 may by an ethernet controller or may make use of any protocol advisable for the coordination of the system 1.

Work cell controller 800 may also communicate with an external “laboratory information system” LIS, either directly or via the router 700. As a variation, each module 100, 200, 300, 400, 500, 600, 900 may communicate with the LIS, either just as a reporting procedure.

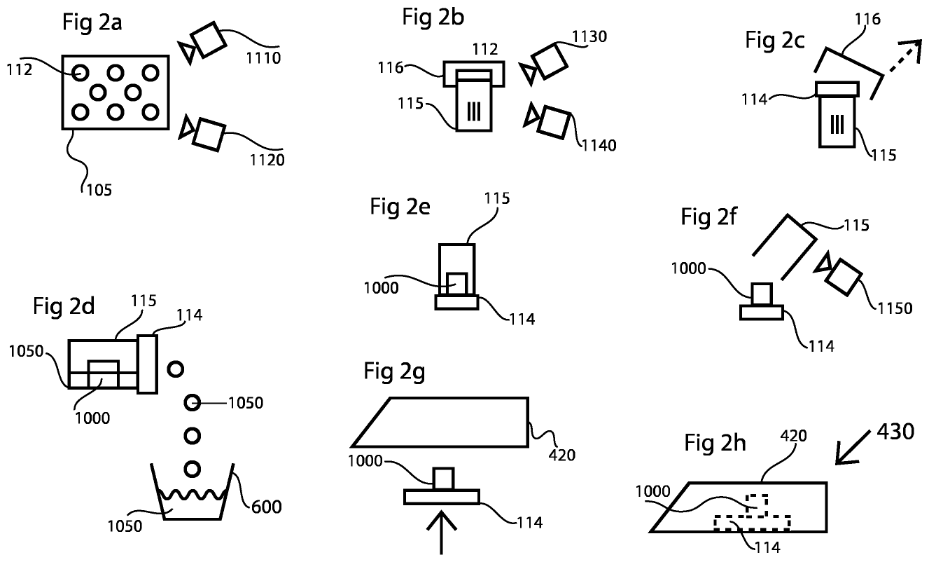

### FIGS. 2a to 2h

FIG. 2a depicts a symbolized rack 105 comprising at least one pathology assembly 112, the container assembly still closed with a container lid (or hatch) (not depicted). Such a container assembly 112 with the still closed container lid forms the pathology assembly 112. The rack 105 can be attained to be deposited into the system (see FIG. 1).

Detectors 1110 and 1120 can be configured to detect the presence and/or an identification code placed on or at the rack 105. Detectors 1110 and 1120 may also be configured to be integrated, thus detecting the presence of the rack 105 can be carried out with one and the same detector itself, such like a camera and/or a reader of electronic signals, like a RFID reader. The detector or electronic signals reader acting as detector 1110 (and 1120) can detect a barcode or any other identifier, like a QR code, an electronically transferred signal or an internal coding used within a laboratory. If such an identifier can be detected, it is most likely that a rack 105 is present and further processing can be resumed. The detection of the presence of a rack can also be achieved by an image taken, a video, an approach sensor, a laser detection system, a weight detector and further detection principles.

FIG. 2b represents a pathology assembly 112, here to be seen as a container body 115 in combination with a lid or hatch 116. The container body 115, formed as a cup or a mug, may comprise a barcode, a QR code or any similar identifier. Even a RFID or any other electronically readable code may be comprised.

A detector 1130 may be adapted to read such a code, optically or electronically readable. A further detector 1140, preferably a camera, may be configured to determine the presence of a sample and/or the size or the properties of the sample. While the detectors 1130 and 1140 may be integrally unified and thus be configured as one camera, the determination of the different information justifies the representation as two detectors.

FIG. 2c depicts a histology or pathology container as it has come from the site that requires a pathological examination of a sample. In the depicted step the lid (or hatch) 116 is removed, the container is opened. Thus, a container assembly is derived. Usually, the lid 116 may be considered as consumable and be disposed of. Under the removed lid 116, the filter 114 appears that is still in abutment with the container body 115. The sample at this stage can rest in the container body.

FIG. 2d in more detail depicts the next step to be taken. The container body 115 with the filter 114 comprise the sample 1000 with a fluid 1050. The fluid 1050 drops out and is collected by a waste and consumables section 600. In this figure, the fluid is represented as a liquid to better demonstrate the idea behind it.

As a result of the step depicted in FIG. 2d, the container body 115 with the filter 114 and the sample 1000, but without the fluid 1050, ends up in an upside-down position, as depicted in FIG. 2e.

FIG. 2e depicts the container body 115 with the sample 1000 resting on the filter 114. The fluid has been removed and is no longer part of the process.

FIG. 2f depicts the removal of the container body 115 from the filter 116. The sample 1000 is supported by the filter 116. A detector 1150 determines the emptiness of the container body 115. Under certain conditions, the sample 1000 can be stuck in the container body. In such a case, the control provision controlling the detector 1150, may initiate an error message to an operator for further activity. The error condition may further derive from an erroneously empty pathology container, i.e., a sample has never been entered into the pathology assembly and thus is also not present in the container assembly and as a result cannot be found at the filter 114.

FIG. 2g depicts a further step to be carried out by the system. A frame 420 can be positioned near the filter 114 and they can be pressed to each other.

FIG. 2h depicts the assembled configuration comprising the filter 114 with the cassette part 420 to form a cassette 430, that can be further handled and/or stored. The sample 1000 can be supported and housed by this assembly and keep the sample 1000 in an appropriate configuration.

### Embodiments

Below, system embodiments will be discussed. These embodiments are identified by the letter S followed by a number. When reference is herein made to system embodiments, these embodiments are meant.

S1. A sample processing system (1) for automatically processing at least one of a histological, a pathological, a medical, a biological, a veterinary and an agricultural sample (1000) positioned in a pathology assembly (112) that is configured to be opened and thus forming a container assembly (112), the system comprising:
a. an imaging section (200) configured to capture images of at least one of the container assembly (112) and the sample (1000);
b. an opening section (200) configured to automatically open the pathology assembly (112); and
c. a cassette-handling section (400) configured to support the sample for further handling; and
d. an output section (500) configured to provide the sample (1000) for further examination.

S2. The sample processing system (1) according to the preceding embodiment wherein the container assembly (112) comprises a conserving, fixating and/or nurturing fluid (1050), the system further comprising:
e. a fluid-handling section (300) configured to automatically remove the fluid (1050) from the container assembly (112) and further configured to perform at least one of handling and disposing of the fluid (1050).

S3. The sample processing system (1) according to any of the preceding embodiments, the system further comprising:
f. a waste and consumables section (600) configured to dispose of at least one of
   i. the fluid (1050); and
   ii. one or more parts of the pathology assembly (112), preferably a container lid (116) and a container body (115); and
   iii. an arrangement to support cassettes that are empty or wrongly marked that are not further used for the handling and examination of the sample (1000).

S4. The sample processing system (1) according to any of the preceding embodiments, the system further comprising at least one of:
g. a cassette management section (900) configured to supply a 1- or 2-dimensional and/or alphanumerical labelling to the frame (420), the label comprising at least one of the following information:
   i. an identifier of the processed sample containers (430); and
   ii. a status information, preferably the status being about urgency and/or external versus internal order; and
   iii. kind of the sample (1000); and
   iv. a time stamp and/or identifier of operator; and
   v. type of subsequent staining needed; and
   vi. classification of care to be observed.

S5. The sample processing system (1) according to any of the preceding embodiments, the system further comprising:
h. an input section (100) for automatically feeding the pathology assembly (112) with the sample into the downstream system (1), the input section (100) being preferably configured to extract a single pathology assembly (112) from a plurality of pathology assemblies (112) positioned in a common support.

S6. The sample processing system (1) according to any of the preceding embodiments, the system further comprising a central controlling component (800) controlling at least two of the input section (100), the imaging section (200), the fluid-handling section (300), the cassette-handling section (400), the output section (500), the waste and consumables section (600) and the cassette management section (900).

S7. The sample processing system (1) according to the preceding embodiment wherein the central controlling component is connected with the sections (100, 200, 300, 400, 500, 600, 900) by a bus structure (700) and/or by a wireless network (700).

S8. The sample processing system (1) according to any of the preceding embodiments, the system further comprising a digital storage for providing information to or storing information from the system, preferably at least one of patient and sample information, preferably a laboratory information system (LIS).

S9. The sample processing system (1) according to the preceding embodiments wherein the digital storage is at least in part remotely located, such as in a cloud.

S10. The sample processing system (1) according to any of the preceding embodiments wherein the opening section (200) is configured to remove a cap from a pathology assembly (112) body by de-capping, the de-capping preferably comprising an unscrewing and/or unlatching of one or more cap elements.

### Modules

S11. The sample processing system (1) according to any of the preceding embodiments with at least one of the further arrangements:
j. the input section (100) being arranged in an input module (100);
k. the imaging section (200) and the opening section (200) being arranged in an imaging and opening module (200);
l. the fluid-handling section (300) being arranged in a fluid-handling module (300);
m. the cassette-handling section (400) being arranged in a cassette-handling module (400);
n. the output section (500) being arranged in an output module (500); and
o. the waste and consumables section (600) being arranged in a waste and consumables module (600); and
p. the cassette management section (900) being arranged in a cassette management module (900).

S12. The sample processing system (1) according to the preceding embodiment with at least an interface transferring a sample between at least one of the following modules:
q. the input module (100) and the imaging and opening module (200);
r. the imaging and opening module (200) and the fluid-handling module (300); and
s. the fluid-handling module (300) and the cassette-handling module (400); and
t. the cassette-handling module (400) and the output module (500); and
u. the cassette management module (900) and the cassette-handling module (400).

S13. The sample processing system according to the two preceding embodiments further comprising a module controlling component for at least one of the modules (100, 200, 300, 400, 500, 600, 900).

### Frame

S14. The sample processing system (1) according to any of the preceding embodiments further comprising an at least partially closed frame (420) configured to at least provide one of:
v. A structure to accommodate the modules (100, 200, 300, 400, 500, 600, 700, 800, 900);
w. Protection of at least one of the modules (100, 200, 300, 400, 500, 600, 700, 800, 900) from environmental influence;
x. Chemical protection of the environment from the effects of hazardous fluid and/or vapor by at least one of a fluid and/or gas tight hood and/or at least one of a fluid and/or gas vent; and
y. Physical protection of the environment from mechanical movements of at least one of the modules (100, 200, 300, 400, 500, 600, 700, 800, 900).

### Input Module

IN1. An input module (100) for automatically feeding a pathology assembly (112) with at least one of a histological, a pathological, a medical, a biological, a veterinary and an agricultural sample downstream, the input module (100) comprising:
a. a support for at least one rack (105), each rack (105) comprising at least one sample container assembly (112) and the input module (100) comprising at least one of:
b. a second detector (1120) assessing the presence and/or position of the rack (105) and/or the presence of at least one pathology assembly (112), the second detector preferably being at least one of a physical, an ultrasonic, an optical and an electronic sensor;
c. a conveyor of the information gained by the second detector (1120) to a work cell controller (800) and/or to a laboratory information system (LIS).
d. a first conveyor system (1212) configured to transport at least one pathology assembly (112) to an imaging and opening module (200).

IN2. An input module (100) according to the preceding embodiment, further comprising a first detector (1110) configured to read an identification of the rack (105), the first detector (1110) preferably being an optical and/or an electronic device reading out the identification of the rack (105).

### Imaging and Opening Module

ID1. An opening module (200) configured to open at least one pathology assembly (112) and thus forming a container assembly (112).

ID2. An opening module (200) according to the preceding embodiment and further comprising an imaging module and thus forming an imaging and opening module (200).

ID3. An imaging and opening module (200) for capturing images of at least one of a container assembly (112) with at least one of a histological, a pathological, a medical, a biological, a veterinary and an agricultural sample and opening the container assembly (112), the imaging and opening module (200) comprising:
a. A third detector (1130) to read out an identification code on the container assembly (112) and/or to determine the size and/or the number of at least one sample (1000);
b. A fourth detector (1140), preferably a camera to determine the size and/or the number of at least one sample (1000).

ID4. The imaging and opening module (200) according to the preceding embodiment conveying the information gained by the third detector (1130) and/or the fourth detector (1140) to a work cell controller (800) and/or to a laboratory information system (LIS).

ID5. The imaging and opening module (200) according to any of the two preceding embodiments, configured to align the container assembly (112) in a pre-determined position for the imaging and opening station (200).

ID6. The imaging and opening module (200) according to any of the preceding embodiments ID3 to ID5, configured to place a container (112) detected to comprise an error condition into an error position, preferably back into the rack (105).

ID7. The imaging and opening module (200) according to any of the preceding embodiments ID3 to ID6, further configured to handle the at least one container within at most 12 seconds, preferable within at most 10 seconds, more preferable within at most 8 seconds, even more preferable within at most 5 seconds, most preferably within at most 3 seconds.

ID8. The imaging and opening module (200) according to any of the preceding embodiments ID3 to ID7, further configured to enable substantially parallel execution of the container handling.

ID9. The imaging and opening module (200) according to any of the preceding embodiments ID3 to ID8, further comprising a second conveyor system (1223) configured to transport an opened container assembly (112) to a fluid-handling module (300).

### Fluid-Handling Module

FL1. A fluid-handling module (300) configured to remove fluid (1050) contained in a container assembly and collect the fluid (1050).

FL2. The fluid-handling module (300) according to the preceding embodiment, further configured to place a sample (1000) for further handling and examination.

FL3. The fluid-handling module according to the embodiments FL1 to FL2, further configured to dispose of the collected fluid (1050) to a waste and consumables module (600).

FL4. The fluid-handling module according to the preceding embodiments FL1 to FL3, further comprising a third conveyor system (1234) configured to transport a container assembly to a cassette-handling module (400).

### Cassette-Handling Module

CH1. A cassette-handling module (400) configured to remove and discharge a container body (115) from a filter (114) supporting a sample (1000).

CH2. The cassette-handling module (400) according to the preceding embodiment, further comprising a fifth detector (1150) to detect the emptiness of the container body (115), in case that the container body is not empty, discharge the container to an error position.

CH3. The cassette-handling module (400) according to the embodiments CH1 to CH2, further configured to receive a frame (420) and abut the filter (114) supporting the sample (1000) and forms a cassette (430).

CH4. The cassette-handling module (400) according to the preceding embodiments CH1 to CH3, further comprising a fourth conveyor system (1245) configured to transport the cassette (430) with the sample (1000) to an output module (500).

### Output Module

OU1. An output module (500) configured to eject the cassette (430) to an unload-position, the unload position being at least one basket to collect at least one cassette (430).

OU2. The output module (500) according to the preceding embodiment, the unload-position being at least one of
a. an arrangement to further handle the cassette; and
b. an arrangement to further examine the sample (1000).

OU3. The output module (500) according to the preceding embodiments OU1 to OU2, further configured to protect the sample (1000) against decay or deterioration.

OU4. The output module (500) according to the preceding embodiment, wherein decay or deterioration is caused by a detrimental degree of environmental humidity.

OU5. The output module (500) according to any of the both preceding embodiments, wherein decay or deterioration is caused by a detrimental temperature.

### Cassette Management Module

CM1. A cassette management module (900) configured to supply a 2-dimensional and alphanumerical labelling to the cassette (430), the label comprising at least one of the following information:
i. an identifier number of the cassette (430); and
j. a status information, preferably the status being about urgency and/or external versus internal order; and
k. kind of the sample (1000); and
l. a time stamp and/or identifier of operator; and
m. type of subsequent staining needed; and
n. classification of care to be observed.

CM2. A cassette management module (900) according to embodiment CM1 configured to label a cassette (430) in a machine-readable form, preferably by at least one of
o. Applying a barcode onto the cassette (430);
p. Applying a data matrix code onto the cassette (430), like a QR code would constitute;
q. Applying a coding to a writable electronic device onto the cassette (430).

Below, method embodiments will be discussed. These embodiments are identified by the letter M followed by a number. When reference is herein made to method embodiments, these embodiments are meant.

### Method

M1. A method for automatically processing at least one of a histological, a pathological, a medical, a biological, a veterinary and an agricultural sample positioned in a container assembly that is configured to be opened, particularly by any system or device according to any of the preceding embodiments, the method comprising the following steps:
a. capturing images of at least one of the container assembly and the sample;
b. automatically open the container assembly;
c. supporting the sample for further handling; and
d. providing for further examination.

M2. The method according to the preceding embodiment wherein the container assembly comprises a conserving, fixating and/or nurturing fluid, the method further comprising the step of automatically removing the fluid from the container assembly and at least one of the step of handling and disposing of the fluid.

M3. The method according to any of the preceding embodiments, the method further comprising the step of dispose of at least one of
i. the fluid; and
ii. one or more parts of the container assembly, preferably a container lid and a container; and
iii. at least one supporting structure of frames
that are not further used for the handling and examination of the sample.

M4. The method according to any of the preceding embodiments, the method further comprising the step of automatically attaching a frame to a filter and thus forming a cassette, the filter preferably supporting the sample for further examination.

M5. The method according to any of the preceding embodiments, the method further comprising the step of automatically feeding the container assembly with the sample into the downstream system and preferably extracting a single container assembly from a plurality of container assemblies positioned in a common support.

M6. The method according to any of the preceding embodiments, the method further comprising the step of controlling at least two of an input section, an imaging section, a fluid-handling section, a cassette-handling section, an output section, a waste and consumables section and a cassette management section.

M7. The method according to any of the preceding embodiments, the method further comprising the step of providing information to or storing information from the system, preferably at least one of a patient and sample information, preferably a laboratory information system (LIS).

M9. The method according to any of the preceding embodiments with the further step of removing a cap from a container assembly body by de-capping, the de-capping preferably comprising an unscrewing and/or unlatching of one or more cap elements.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be the preferred order, but it may not be mandatory to carry out the steps in the recited order. That is, unless otherwise specified or unless clear to the skilled person, the order in which steps are recited may not be mandatory. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

Wherever a filter is mentioned, also the assembly of the filter with the filter lid is addressed.

The expression “rack” comprises any wrapping of one or more containers or cassettes, like a funnel, a bucket, a sack, a box, a shelf, a holder or a receptacle or a repository would constitute.

1. A sample processing system for automatically processing at least one of a histological, a pathological, a medical, a biological, a veterinary and an agricultural sample positioned in a container assembly that is configured to be opened, the system comprising:
a. an imaging section configured to capture images of at least one of the container assembly and the sample;
b. an opening section configured to automatically open the container assembly; and
c. a cassette-handling section configured to support the sample for further handling; and
d. an output section configured to provide the sample for further examination.

2. The sample processing system according to claim 1 wherein the container assembly comprises a conserving, fixating and/or nurturing fluid, the system further comprising:
e. a fluid-handling section configured to automatically remove the fluid from the container assembly and further configured to perform at least one of handling and disposing of the fluid.

3. The sample processing system according to claim 2, the system further comprising:
f. a waste and consumables section configured to dispose of at least one of
i. the fluid; and
ii. one or more parts of the container assembly, preferably a container lid and a container body; and
iii. an arrangement to support frames
that are not further used for the handling and/or examination of the sample.

4. The sample processing system according to claim 2, the system further comprising:
g. a cassette management section configured to print and/or attach an identifier onto a frame.

5. The sample processing system according to claim 2, the system further comprising:
h. an input section for automatically feeding the container assembly with the sample into the downstream system, the input section being preferably configured to extract a single container assembly from a plurality of container assemblies positioned in a common support.

6. The sample processing system according to claim 2, wherein more than one of any
input section,
imaging section,
opening section,
fluid-handling section,
cassette-handling section,
output section,
waste and consumables section,
cassette management section
is comprised.

7. The sample processing system according to claim 7, the system further comprising a central controlling component controlling at least two of the input section, the opening section, the imaging section, the fluid-handling section, the cassette-handling section, the output section, the waste and consumables section and the cassette management section.

8. The sample processing system according to claim 7 wherein the central controlling component is connected with the sections by a bus structure and/or a wireless network.

9. The sample processing system according to claim 7, the system further comprising a digital storage for providing information to or storing information from the system, preferably at least one of patient, process and sample information, preferably a laboratory information system.

10. The sample processing system according to claim 7 wherein the digital storage is at least in part remotely located, such as in a cloud.

11. The sample processing system according to claim 2 wherein the opening section is configured to remove a cap from a container assembly body by de-capping, the de-capping preferably comprising an unscrewing and/or unlatching of one or more cap elements.

12. The sample processing system according to claim 2 with at least one of the further arrangements:
a. the input section being arranged in an input module;
b. the imaging section and the opening section being arranged in an imaging and opening module;
c. the fluid-handling section being arranged in a fluid-handling module;
d. the cassette-handling section being arranged in a cassette-handling module;
e. the output section being arranged in an output module; and
f. the waste and consumables section being arranged in a waste and consumables module; and
g. the cassette management section being arranged in a cassette management module.

13. The sample processing system according to claim 12 with at least one interface transferring a sample between at least two of the following modules:
h. the input module and the imaging and opening module;
i. the imaging and opening module and the fluid-handling module; and
j. the fluid-handling module and the cassette-handling module; and
k. the cassette-handling module and the output module; and
l. the cassette management module and the cassette-handling module.

14. The sample processing system according to claim 12 further comprising a module controlling component for at least one of the modules.

15. A method for automatically processing at least one of a histological, a pathological, a medical, a biological, a veterinary and an agricultural sample positioned in a container assembly that is configured to be opened, particularly by any system or device according to any of the preceding claims, the method comprising the following steps:
a. capturing images of at least one of the container assembly and the sample;
b. automatically open the container assembly;
c. supporting the sample for further handling; and
d. providing provide for further examination.

16. The method according to claim 15 wherein the container assembly comprises a conserving, fixating and/or nurturing fluid, the method further comprises the step of automatically removing the fluid from the container assembly and at least one of the steps of handling and disposing of the fluid.

17. The method according to claim 15 further comprising the step of providing information to or storing information from the system, preferably at least one of a patient and sample information, preferable a laboratory information system (LIS).
